(19) United States
(12) Patent Application Publication
(10) Pub. No.: US 2015/0260578 A1
(43) Pub. Date: Sep. 17, 2015

(54) COLOR MEASUREMENT APPARATUS, METHOD OF MEASURING A COLOR AND COLOR MEASUREMENT SYSTEM

(71) Applicants: Yuki Hayashi, Sagamihara-shi (JP); Morihiro Takagi, Yokohama-shi (JP)

(72) Inventors: Yuki Hayashi, Sagamihara-shi (JP); Morihiro Takagi, Yokohama-shi (JP)

(21) Appl. No.: 14/640,874

(22) Filed: Mar. 6, 2015

(30) Foreign Application Priority Data
Mar. 14, 2014 (JP) 2014-052760
Feb. 19, 2015 (JP) 2015-030352

(51) Int. Cl. G01J 3/46

(52) U.S. Cl. CPC G01J 3/463; G01J 2003/467

(57) ABSTRACT

A color measurement apparatus measures a color distribution of an object that includes a first substance and a second substance. The color measurement apparatus comprises an imager that captures an image of the object, the image being two dimensional and the image includes a first color feature of the first substance and a second color feature of the second substance. Furthermore, the color measurement apparatus comprises a calculator that calculates distribution information of the first substance and the second substance based on the image.

### CROSS-REFERENCE TO RELATED APPLICATIONS

The present application is based on and claims priority to Japanese Application Number 2014-052760, filed on Mar. 14, 2014 and Japanese Application Number 2015-030352, filed on Feb. 19, 2015, the disclosure of which is hereby incorporated by reference in its entirety.

### BACKGROUND

The present invention relates to the measurement of a color of an object, and more particularly to the measurement of a color distribution of a plurality of substances in an object.

A conventional liquid color measurement apparatus typically includes a container which contains a liquid. The conventional liquid color measurement apparatus may further include a pump which transfers the liquid from the container to a color measurement cell, and a color measurement device which measures a color of the liquid in the color measurement cell.

While a conventional liquid color measurement apparatus can measure a color of liquid, the conventional liquid color measurement apparatus cannot measure a color distribution of an object such as a liquid at one time. Therefore, it is difficult to measure a color distribution of different substances in an object with a conventional liquid color measurement apparatus. It is also difficult to measure a color distribution of a blot in an object with a conventional liquid color measurement apparatus.

### SUMMARY

The embodiments of the present invention provide a color measurement apparatus measures a color of an object including a first substance and a second substance. The color measurement apparatus comprises an imager which takes an image of the object, and gets a two dimensional image which includes a feature of a color of the first substance and a feature of a color of the second substance. Furthermore, the color measurement apparatus comprises a calculator calculates a distribution information of the first substance and the second substance based on the two dimensional image.

### BRIEF DESCRIPTION OF THE DRAWINGS

FIG. 1 illustrates a functional block diagram of a color measurement apparatus according to an embodiment of the present invention.

FIG. 2 illustrates a state where a camera captures an image of liquid surface of an object.

FIG. 3 illustrates a two dimensional image which is captured by a camera.

FIG. 4 illustrates a camera.

FIG. 5 illustrates a color filter.

FIG. 6 illustrates a spectral transmittance of a color filter when an angle of incidence of a light ray is 0 degree.

FIG. 7 illustrates a view of lens array from an optical axis.

FIG. 8 illustrates an image on an image plane.

FIG. 9 illustrates a macro-pixel.

FIG. 10 illustrates an occupation area of a first substance and an occupation area of a second substance.

FIG. 11 illustrates a distance between two adjacent second substances.

FIG. 12 illustrates a system including a display which displays distribution information.

FIG. 13 illustrates a method of measuring a color of an object.

### DETAILED DESCRIPTION OF THE EMBODIMENTS

Embodiments of a color measurement apparatus are explained below with accompanying drawing.

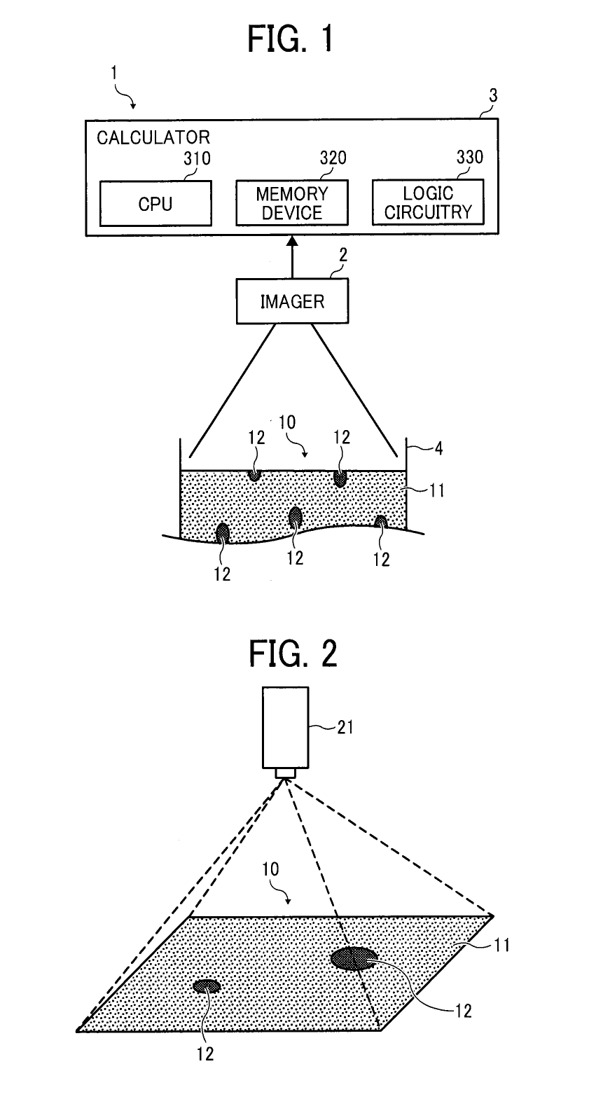

FIG. 1 illustrates a functional block diagram of a color measurement apparatus 1 according to a present embodiment. Color measurement apparatus 1 measures a color of object 10 which is contained in a container 4. The color measurement apparatus 1 includes an imager 2 and a calculator 3.

In the present embodiment, object 10 includes a first substance 11 and a second substance 12. The first substance 11 is a water-based liquid and the second substance 12 is an oil-based liquid. Proportionally, the second substance 12 is of a low ratio in relation to the first substance 11. As illustrated in FIG. 1, most of volume inside the container 4 is occupied by the first substance 11. FIG. 1 further illustrates that the second substance 12 is dispersed and insoluble in the first substance 11.

The imager 2 measures a color or spectrum of the object 10. The imager 2 measures a color of the object 10 in quantitative terms. For example, the imager 2 may utilize a photoelectric colorimeter, a spectral photometer or a standard or reference color for comparison with the captured image of object 10. Imager 2 may include camera 21, as illustrated in FIG. 2.

In an exemplary implementation, imager 2 captures an image of a liquid surface of the object 10 from above the container 4. FIG. 2 illustrates a state where a camera 21 captures an image of the liquid surface of an object 10.

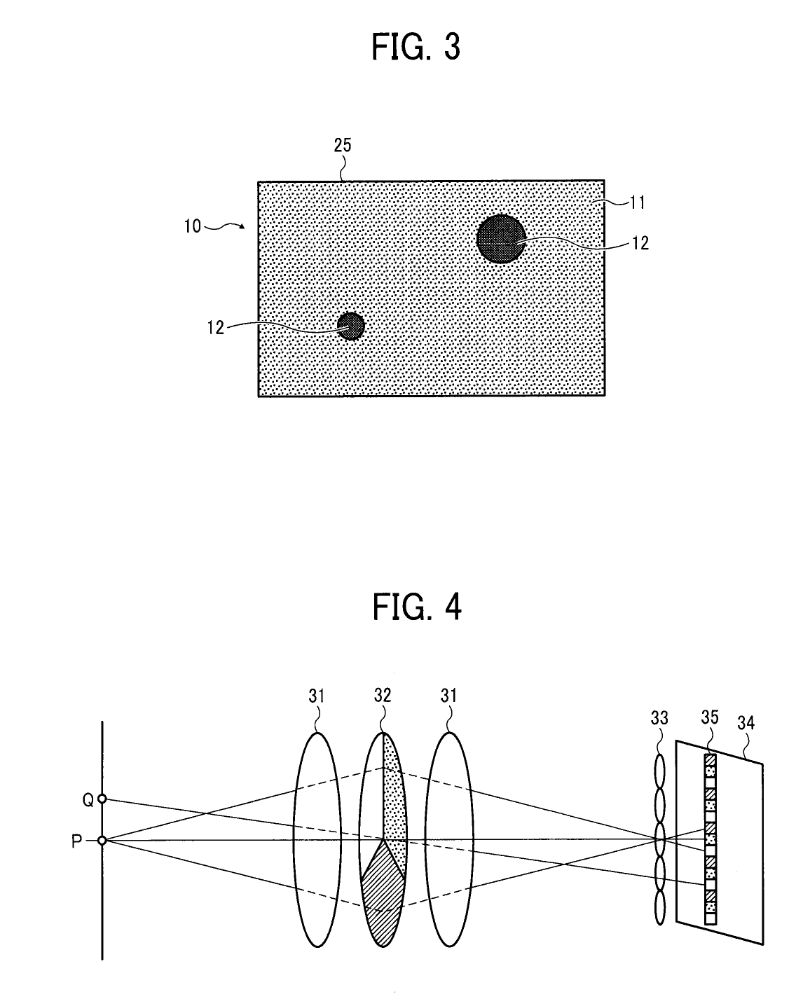

FIG. 3 illustrates a two dimensional image 25 which is captured by a camera 21. The two dimensional image 25 includes a feature of a color of the first substance 11 and a feature of a color of the second substance 12. The feature of a color of the first substance 11 is a color, pattern, spectrum, or other feature specific to the first substance 11 that is included in the two dimensional image 25 of the object 10. The feature of a color of the second substance 12 is a color, pattern, spectrum, or other feature specific to the second substance 12 that is included in the two dimensional image 25 of the object 10. The color or spectrum of the first substance 11 appearing on a liquid surface of object 10 is different from the color or spectrum of the second substance 12 appearing on the liquid surface of object 10.

FIG. 4 illustrates an internal structure of the camera 21. A main lens 31 may comprise a single lens or a plurality of lenses. In this embodiment, the main lens 31 includes a plurality of lenses. Camera 21 further includes color filter 32, which has a spectral transmittance based on a color-matching function of an XYZ color system, is arranged in a position of a diaphragm of the main lens 31.

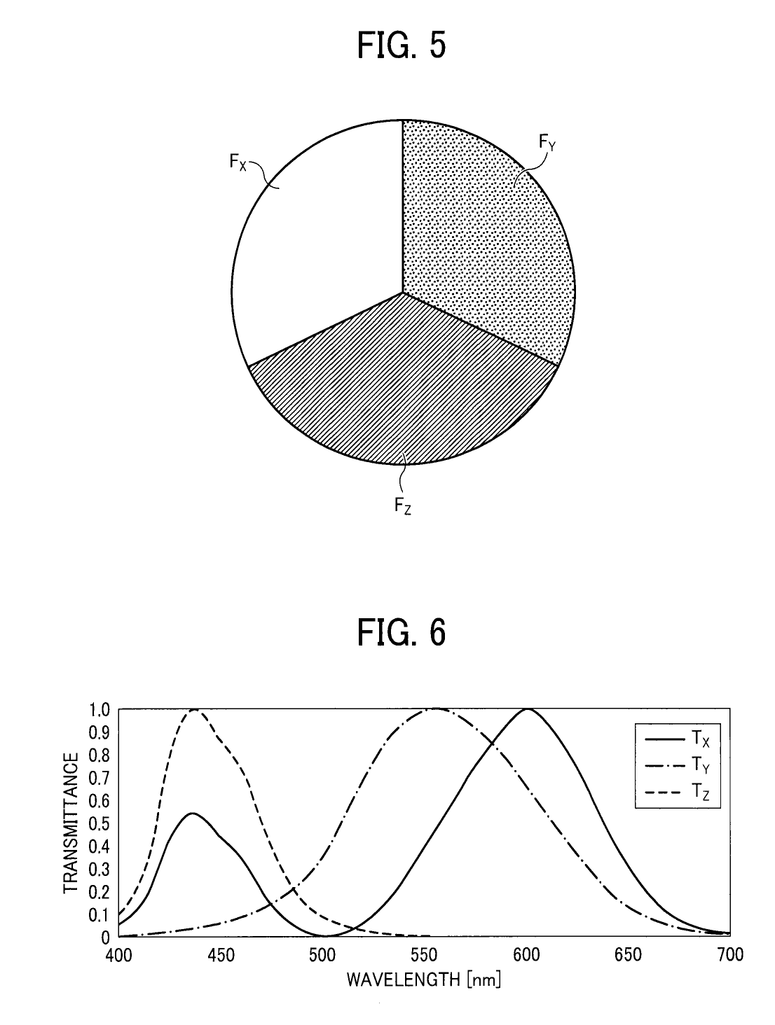

FIG. 5 illustrates color filter 32. FIG. 6 illustrates a spectral transmittance of a color filter 32 when an angle of incidence of a light ray is 0 degree.

As illustrated in FIG. 6, Tx is a spectral transmittance of Fx area shown in FIG. 5, Ty is a spectral transmittance of Fy area shown in FIG. 5, and Tz is a spectral transmittance of Fz area shown in FIG. 5. In FIG. 6, a continuous line, a broken line and a dotted line show spectral transmittance Tx(λ), Ty(λ) and Tz(λ) of the color filter Fx, Fy and Fz based on a following color-matching function (1), respectively.

x̅(λ), y̅(λ), z̅(λ) (1)

Tx(λ), Ty(λ) and Tz(λ) are normalized values when each maximum values of Tx(λ), Ty(λ) and Tz(λ) are 100% transmittance. For example, in the case of setting a maximum value of a signal of a light through the color filter Fx to one-tenth of a maximum value of the signal of a light though the color filter Fy or Fz, the value of signal of a light through the color filter Fx is adjusted by signal preprocessing according to a setup value. There is another way in which a transmittance of the color filter Fx is made small, but the way cause a bigger effect of a disturbance in a signal because an amount of light through the color filter becomes smaller. Signal-to-noise ratios (SN ratios) of color filters correspond to x(λ), y(λ) can be improved by normalization described above.

The color filter 32 is divided equally among three in a fan shape, as illustrated in FIG. 5, but color filter 32 is not limited to that. The color filter 32 may be, for example, divided in half, or divided equally among four. Moreover, color filter 32 may be configured in a square shape, or any other shape. Furthermore, a division ratio of colors in the color filter 32 does not need to be equal.

As illustrated in FIG. 4, camera 21 further includes lens array 33. Lens array 33 includes a plurality of small lenses located near a condensing position of the main lens 31. Camera 21 further includes light receiving element 35, which is located at an image plane 34. The light receiving element 35 is a monochrome sensor which does not have a color filter.

A light which enters the main lens 31 is a group of light rays. Each light ray passes through a different position of the diaphragm of the main lens 31. In the present embodiment, the three color filters of the color filter 32 are located at the position of the diaphragm of the main lens 31. Each light ray passes through each of the three color filters having different spectral transmittance respectively. The light rays which pass through the color filter 32 condense near the lens array 33 and then each of the light rays reach a different position of the sensor respectively through the lens array 33. In other words, a light emitted from one point of an object is analyzed into spectral tristimulus values X, Y, Z, and then the values are measured.

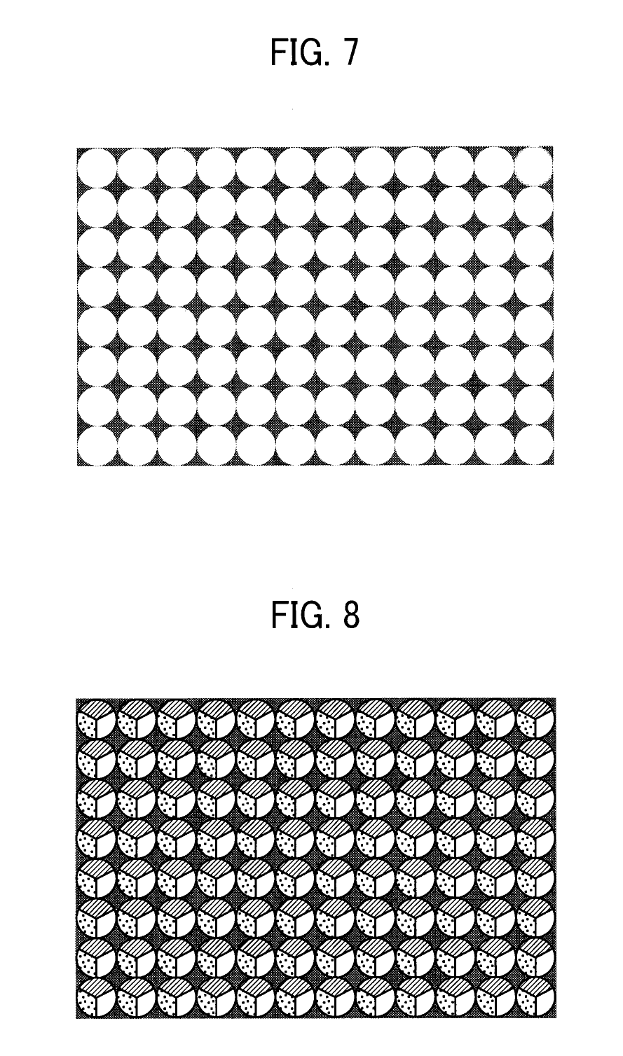

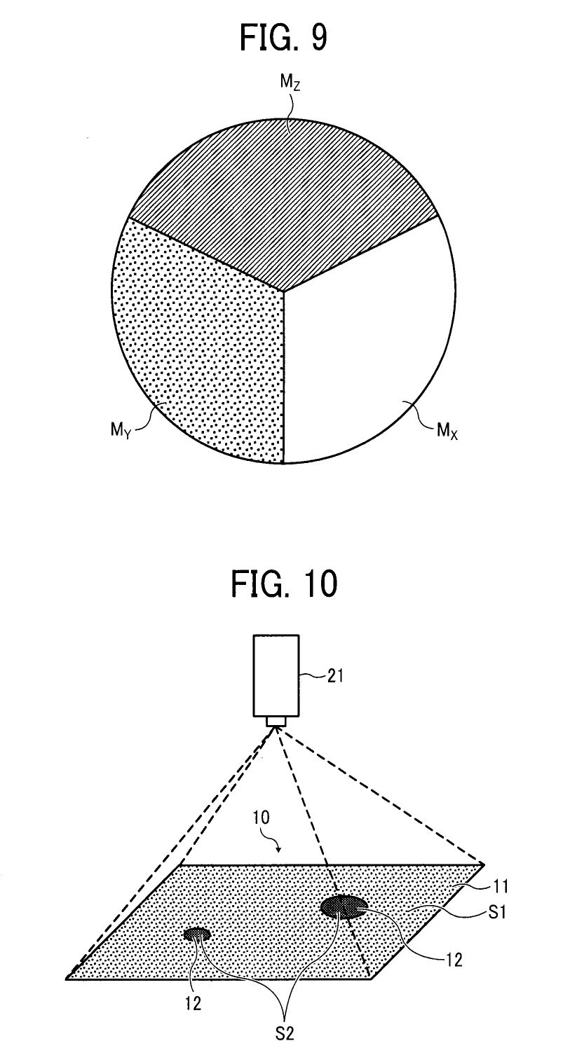

FIG. 7 illustrates a view of the lens array 33 from an optical axis of the lens array 33. FIG. 8 illustrates an image on the image plane 34. The image photographed with the structure shown in FIG. 4 is an array of small circles shown in FIG. 8. In FIG. 8, each small circle is called macro pixel. A shape of a macro pixel becomes circular because the diaphragm of the main lens 31 is circular. However, if a shape of the diaphragm of the main lens 31 is quadrangular, the shape of macro pixel becomes quadrangular.

FIG. 9 is an enlarged illustration of an exemplary macro pixel. As illustrated in FIG. 9, Mx, My and Mz in the macro pixel represent distributions that are formed by light through color filters Fx, Fy and Fz, respectively. A color measurement is performed by processing output values of Mx, My and Mz according to a multiple linear regression analysis or Wiener estimation, for example.

Returning to discussion of FIG. 1, calculator 3 calculates a distribution information of the first substance 11 and the second substance 12 based on two dimensional image 25 which is captured by the imager 2 (the camera 21). The distribution information is represented in a plane view. The distribution information is information that describes a dispersion state of the first substance 11 and the second substance 12 in the object 10, such as a ratio of an occupation area of the first substance 11 and an occupation area of the second substance 12 in the two dimensional image 25, a positional relationship between the second substances 12 in the two dimensional image 25, a density of the second substance 12 in the two dimensional image 25, for example.

The calculator 3 comprises CPU 310, a memory device 320, such as ROM or RAM, that stores a program to control the CPU 310, and a variety of logic circuitry 330. However, a configuration of the calculator 3 is not particularly limited to such hardware components. For example, calculator 3 may comprise an independent computer. Alternatively, calculator 3 may be contained in a same device as the camera 21 (the imager 2). Further, the functionality of calculator 3 may be stored within a computer readable recording medium such as memory device 320, and memory device 320 may include a CD-ROM, Flexible Disk (FD), CD-R DVD or other storage memory as a file in an installable format or as a file in an executable format. Such a program can be stored in a computer connected with a network such as internet and provided through the network to a computer, processor or other device by download. Further, the program can be provided or distributed through a network such as internet.

The calculator 3 calculates an occupation area of the first substance 11 and an occupation area of the second substance 12. Calculator 3 may also calculate a ratio of an occupation area of the first substance 11 and an occupation area of the second substance 12. Further, calculator 3 may calculate a position of the second substance 12, the distance between the first substance 11 and the second substances 12 based on a two dimensional image 25.

FIG. 10 illustrates an occupation area S1 of the first substance 11 and an occupation area S2 of the second substance 12. In FIG. 10, there are two occupation areas S2 of the second substance 12. The occupation area S2 of the second substance is a total sum of each areas of these two areas. The same is true in the case that there are equal to or more than three areas of the second substance 12.

Calculator 3 may calculate the occupation area Si of the first substance 11 by subtracting the occupation area S2 of the second substance from a whole area of the two dimensional image 25 (see FIG. 3). A ratio SR of an occupation area S1 of the first substance 11 and an occupation area S2 of the second substance 12 can be represented by a formula such as SR=S1/S2 or SR=S2/S1. An area of the second substance 12 can be determined by detecting a boundary line between a value which shows a color of the first substance 11 and a value which shows a color of the second substance 12 in coordinate axes of the two dimensional image 25 with a known image recognition technology. The value which shows a color is such as a value of chromaticity coordinate values (x, y). Values (x1, y1) corresponding to the first substance 11 and values (x2, y2) corresponding to the second substance 12 are different. The boundary line is a boundary line between a position of values (x1, y1) and a position of values (x2, y2).

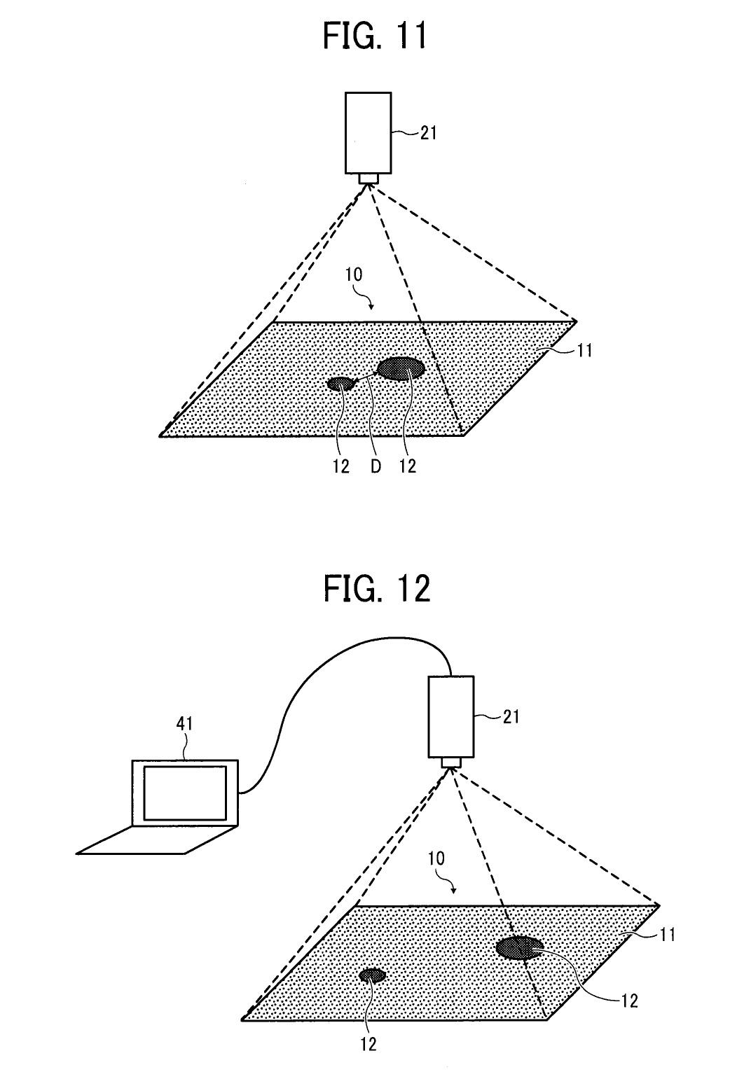

FIG. 11 illustrates a distance D between two adjacent second substances 12. The distance D is calculated based on a position and boundary line of each of the second substances 12 in an imaging area of the camera 21 (the two dimensional image 25). The calculator 3 may treat two adjacent second substances 12 as one second substance 12 if the distance D is shorter than a prescribed value. For example, the prescribed value may be small in such a degree so as to treat two adjacent second substances 12 as one second substance 12 in terms of a distribution. Therefore, it is possible to avoid an unnecessary complication of a distribution information of the second substance 12 in the two dimensional image 25.

FIG. 12 illustrates a system including a display device 41 which displays a distribution information. The display device 41 is an information-processing equipment such as a personal computer or tablet computer. The information-processing equipment has a color display which displays a distribution information which is calculated by the calculator 3, for example. The two dimensional image 25 which is taken by the camera 21 may be displayed on the display device 41. The calculator 3 may make a distribution image (a two dimensional image) from the distribution information and the display device 41 may display the distribution image. The first substance 11 and the second substance 12 in the two dimensional image 25 may be displayed in difference colors on the display device 41 in pixels if the first substance 11 and the second substance 12 have difference colors, for example.

The values of occupation area S1 of the first substance 11, an occupation area S2 of the second substance 12, a distance D between two adjacent second substances 12 to a two dimensional image may be displayed on the display device 41. This will enable the following that a distribution state of the first substance 11 and the second substance 12 can be figured out clearly through the eye of users. The two dimensional image 25 including the first substance 11 and the second substance 12 are taken, colors of each point in the whole image are calculated by the calculator 3, areas or distances are calculated by the calculator 3, and then these results are displayed on the display device 41.

FIG. 12 shows a system that the camera 21 and the display device 41 are connected directly, but is not limited to that. In the system shown in FIG. 12, the calculator 3 may be included in either one of the camera 21 or the display device 41. The calculator 3 may be provided as an independent hardware between the camera 21 and the display device 41. For example, camera 21 may capture the image and transmit the image to calculator 3, which then may calculate the distribution information. Moreover, calculator 3 may then transmit the distribution information to display device 41.

The above embodiments illustrate that both the first substance 11 and the second substance 12 are a liquid, but a color measurement apparatus in accordance with this application is not limited to that. For example, either one or both of the first substance 11 and the second substance 12 may be a solid, a gel, or may possess other physical characteristics, for example. It can be thought that there are cases where a liquid such as paint gets hard and becomes a solid. It can be thought that there are cases where the container 4 is such as a bath or a pool, the first substance 11 is water, the second substance 12 is a blot. In such a case, a distribution of blots including in water of a bath or a pool can be confirmed by a color measurement apparatus in accordance with this application. The above embodiments illustrate that there are two substances in the object 10 of a measuring a color, but a color measurement apparatus in accordance with this application is not limited to that. For example, a distribution information can be calculated when there are more than two color substances in object 10.

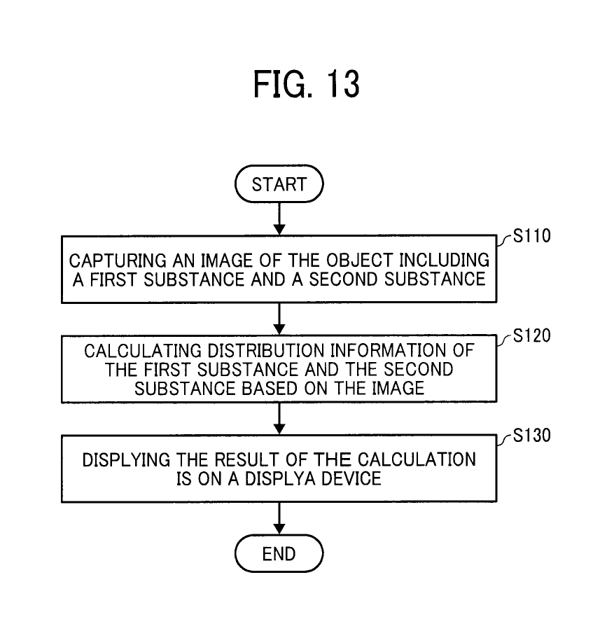

FIG. 13 illustrates a method of measuring a color of an object. In an exemplary implementation of the method illustrated in FIG. 13, imager 2 captures an image of the object including the first substance 11 and the second substance 12 (S110). The image is two dimensional and the image includes a first color feature of the first substance 11 and a second color feature of the second substance 12. Next, calculator 3 calculates distribution information of the first substance 11 and the second substance 12 based on the image (S120). After calculation of the distribution information, display device 41 then displays the calculated distribution information (S130).

As set forth hereinabove, according embodiments of the present invention, a distribution of several different substances in an object of a color measurement and a distribution of a blot in an object of a color measurement and so on can be measured effectively with the color measurement apparatus 1.

What is claimed is:

1. A color measurement apparatus, comprising:
an imager that captures an image of an object including a first substance and a second substance, the image being two dimensional and the image including a first color feature of the first substance and a second color feature of the second substance; and
a calculator that calculates distribution information of the first substance and the second substance based on the image.

2. The color measurement apparatus according to claim 1, further comprising a container which contains the object, wherein
the imager captures the image of the object from above the container.

3. The color measurement apparatus according to claim 1, wherein the distribution information includes at least one of a first occupation area of the first substance in the image and a second occupation area of the second substance in the image.

4. The color measurement apparatus according to claim 1, wherein the distribution information includes a first position of the first substance in the image and a second position of the second substance in the image.

5. The color measurement apparatus according to claim 4, wherein
the object includes a first part and a second part of the second substance,
the first part and the second part of the second substance are located within the first substance,
the calculator calculates a distance between the first part and the second part of the second substance, and
the distribution information includes the distance calculated by the calculator.

6. The color measurement apparatus according to claim 5, wherein
when the distance is shorter than a prescribed value, the calculator calculates the distribution information by treating the first part and the second part of second substance are a single second substance.

7. The color measurement apparatus according to claim 1, further comprising a display which displays the distribution information.

8. The color measurement apparatus according to claim 7, wherein
the calculator generates a distribution image by transforming the distribution information, the distribution image being two dimensional, and
the display displays the distribution image.

9. The color measurement apparatus according to claim 1, wherein
the first substance is a water-based liquid, and
the second substance is an oil-based liquid.

10. The color measurement apparatus according to claim 1, wherein one of the first substance and the second substance is a liquid, and the other one of the first substance and the second substance is a solid.

11. The color measurement apparatus according to claim 2, wherein
the first substance is a liquid that occupies the container, and
the second substance is a blot.

12. A method of measuring a color of an object, the method comprising:
capturing an image of the object including a first substance and a second substance, the image being two dimensional and the image including a first color feature of the first substance and a second color feature of the second substance; and
calculating distribution information of the first substance and the second substance based on the image.

13. The method of measuring a color of an object according to claim 12, wherein
the object is within a container, and
the image of the object is captured from above the container.

14. The method of measuring a color of an object according to claim 12, wherein the distribution information includes at least one of a first occupation area of the first substance in the image and a second occupation area of the second substance in the image.

15. The method of measuring a color of an object according to claim 12, wherein the distribution information includes a first position of the first substance in the image and a second position of the second substance in the image.

16. A color measurement system, comprising;
a calculator; and
an imager separate from the calculator, the imager captures an image of an object and transmits the image to the calculator, the object including a first substance and a second substance, the image being two dimensional and the image including a first color feature of the first substance and a second color feature of the second substance; and
the calculator receives the image from the imager and calculates distribution information of the first substance and the second substance based on the image.

17. The color measurement system according to claim 16, further comprising a container which contains the object, wherein
the imager captures the image of the object from above the container.

18. The color measurement apparatus according to claim 16, wherein the distribution information includes at least one of a first occupation area of the first substance in the image and a second occupation area of the second substance in the image.

19. The color measurement system according to claim 16, wherein the distribution information includes a first position of the first substance in the image and a second position of the second substance in the image.

20. The color measurement system according to claim 19, wherein
the object includes a first part and a second part of the second substance,
the first part and the second part of the second substance are located within the first substance,
the calculator calculates a distance between the first part and the second part of the second substance, and
the distribution information includes the distance calculated by the calculator.
